(19) United States
(12) Patent Application Publication
(10) Pub. No.: US 2012/0185077 A1
(43) Pub. Date: Jul. 19, 2012

(54) METHOD FOR CONTROLLING AND OPERATING A PRODUCTION CELL, AND A CONTROL DEVICE

(75) Inventors: Daniel Müller, Kaltbrunn (CH); Björn Denzler, Rapperswil-Jona (CH); Manfred Hausmann, Mollis (CH)

(73) Assignee: Netstal Maschinen AG, Naefels (CH)

(21) Appl. No.: 13/499,523

(22) PCT Filed: Sep. 24, 2010
(86) PCT No.: PCT/EP2010/064138

§ 371 Date: Mar. 30, 2012

(30) Foreign Application Priority Data
Oct. 8, 2009 (DE) 102009048746.8

(51) Int. Cl. B29C 45/00

(52) U.S. Cl. 700/200

(57) ABSTRACT

The present invention relates to a device and to a method for controlling and operating a production cell including at least a part of the peripheral equipment associated therewith. Machine sequences based on machine control components that are part of a domain model are established, managed, and executed using a domain language. For a free configurability of machine control components, it is proposed to select a machine control component from a set of predetermined component types, to allocate an admissible technology from a set of technologies to a machine control component, wherein for each technology of a component type a logic is stored, which comprises and defines the interfaces required for the machine control component and the technology, and to connect the connection interfaces of the machine control component to hardware inputs and outputs of existing connections of the production cell.

The present invention relates to a method for controlling and operating a production cell, and to a control device according to the preamble of claims 1 and 10, respectively.

A method for controlling and operating a production cell and a control device of a generic type are known from WO 2006/089451. The production sequence for a production cell is hereby defined and parameterized by an operator. A component-oriented control is used, wherein the components may be machine control components, such as the mold closure, an assembly, a core puller, handing devices, etc. These machine control components are imaged virtually in the control, and the production sequence can be defined with a domain language by way of a domain model.

This is described in more detail in WO 2006/089451, in particular how to generate, administer and execute machine sequences based on full-performance components, which together form a domain model, with the help of a technical domain language. This solution allows the components to be displayed on the display screen interface or control interface, so that they can be used by the operator as basis for modeling various sequences. The domain language is used for each problem space in the control to describe solutions and to automatically generate therefrom the program code.

However, the aforementioned approach does not completely address the increasing desire for a greater variability when using an injection molding machine or a production cell.

In an injection molding process, the design of an injection-molded part is defined by the injection molding tool. However, the same injection molded part should frequently not be produced, but different parts. Although this can be generally accomplished with an injection molding machine, the mold and possibly additional peripheral devices need to be exchanged or altered. The injection molding machine is thus typically not a single-purpose machine and the production cell can be reconfigured accordingly by exchanging components of the system, molds and peripheral devices.

An injection molding machine is advantageously constructed such that the mold and the plasticization can be changed and different peripheral devices can be connected. A mold has frequently several actuators and sensors. The actuators can drive certain parts linearly, rotationally or in other ways, which is typically referred to as drive axes. The mold or the peripheral devices have connections for their actuators and sensors, which must be operated in an appropriate manner. In other words, controlling these mold axes as well as the axes of the injection molding machine itself, but also the peripheral devices for a machine sequence (e.g., production sequence, injection sequence, closure force settings, etc.) must be properly coordinated. The connections of the actuators and sensors of the molds and peripheral devices are hereby connected with suitable connections of the injection molding machine, which are controlled by the control device. Sensors may also be external monitoring devices, such as a camera system or a weighing system. Inputs can also be used for synchronizing with peripheral devices. The production sequence with an installed mold and existing peripheral devices, but also additional machine sequences, can be defined or adapted by an installer of the injection molding machine.

To operate the mold or the peripheral devices, the mold or the peripheral devices are typically connected via connections disposed on the injection molding machine. These connections will be referred to hereinafter as hardware inputs and hardware outputs of the connections of an injection molding machine or production cell. They represent the inputs and outputs for the actuators and sensors.

The interfaces of the mold axes and of the peripheral devices are hereby connected in a logical manner with the connections provided on the injection molding machine.

Until now, the desired connections were specified and accordingly provided when the injection molding machine was ordered, wherein the different molds or mold types and peripheral device connections must already be known. The connections disposed on the injection molding machine for actuators and sensors as well as the outputs and inputs (analog or digital) are hereby typically device-specific and cannot be flexibly used. For example, an injection molding machine with connections for two hydraulic ejectors and two hydraulic core pullers may be provided, and a third core puller may be implemented in a mold which can now no longer be connected to the—as described above—preconfigured injection molding machine due to the lack of additional connections, although suitable hydraulic or electric (or pneumatic or controlled connections) may possibly exist which, however, are provided for other applications (e.g. for the ejector).

It is therefore an object of the present invention to provide a method for controlling and operating a production cell as well as a control device, with which equipment installed on an injection molding machine can be used flexibly and device- specific. In particular, the operator of an injection molding machine should be able to produce machine control components from universally usable hardware elements (actuators and sensors).

This object is attained with the features recited in claims 1 and 10 for the method and the device, respectively.

A core concept of the present invention is therefore a method for controlling and operating a production cell and a control device based on WO 2006/089451, wherein machine control components can be newly created or altered as part of the domain model and the connections of these created or altered machine control components are then allocated to existing and universally usable hardware connections (i.e. hardware inputs and outputs). This is accomplished in the steps that (i) a machine control component is selected from a set of predetermined component types, that (ii) a technology from potential technologies for the selected component type is allocated to the selected machine control component having a specific associated component type, wherein for each technology of the component type a suitable logic for controlling the axis or the device is stored, which includes and defines the interfaces required for the technology, and that (iii) the connection interfaces of the thus created machine control components are connected with and/or allocated to corresponding hardware inputs and outputs of existing connections—i.e. existing connections for actuators and/or sensors—of the injection molding machine.

Overall, a new machine control component can be set up whose associated commands about the sequence editor which are defined in the stored logic can be inserted in the production sequence. When a new machine control component is set up in the domain model, allocated to the existing hardware connections and activated (wherein activation refers to loading the machine control component into the machine controller), the machine control component can be displayed on the display screen and controlled via control keys. For example, a keyboard on the display screen can be used, as described in EP 2 100 197 A1, which allows to dynamically define and label the haptic control keys and to provide the control keys with a symbol. This now becomes possible also for those machine components which are set up by the machine operator.

The symbol and labeling of the set-up display screen keys can preferably be adapted by the user. FIG. 2 illustrates a diagram for generating the machine control components (these are actually auxiliary control components in FIG. 2).

According to FIG. 2, different information is available in three storage areas. The first storage area includes a description of the hardware connections existing in the injection molding machine (i.e. hardware inputs and outputs) which are read in when the machine is started up. The configuration and equipment of the injection molding machine are described in this hardware description of the hardware connections. In this hardware description (file), which is also referred to as hardware “pool”, only hardware elements are included that are physically present on the injection molding machine. This memory area preferably also administers the use of the equipment.

The storage area “repository”, which is also referred to as machine control component pool, stores all existing machine control components or machine control components set up by the operator, which are then available in the sequence editor. The commands of these machine control components can then be used in the production sequence.

The storage area “model” stores the entire logic. The different elements and machine control components are, inter alia, also described with the domain language.

When setting up a new machine control component (this will be described hereinafter with reference to an exemplary auxiliary control component), a machine control component is generated, when desired and as far as technically feasible, for example with a software assistant (also referred to as Wizard). A user or installer first selects from a set of defined component types a machine control component (e.g. a standard core puller) and then allocates to this machine control component having the selected component type a technology from a set of technologies defined for this component type. The component type may be, for example, an ejector and the technology may determine, for example, if the ejector is operated hydraulically, pneumatically or electrically. The computer/storage device includes information how each component type is constructed and which technologies are allowed for this component type.

After the component type and the technology for a new machine control component are known, the software assistant can be closed, the machine control component generated and stored in the machine control component pool. From here on, the machine control component can be used outside the machine configuration (e.g. in the sequence editor). However, the machine controller can not yet be activated at this time, because the allocations to the hardware connections on the machine are missing. In other words, the machine control component is initially generated in the domain model and must now be adapted to the physical environment. For this purpose, a user connects the connection interfaces of the machine control component created by the software assistant with the actual connections that exist on the injection molding machine, namely the hardware inputs and outputs (subsequently also referred to as hardware elements) from the hardware pool. The controller is hereby constructed so that only matching hardware elements having a correct type can be allocated to the corresponding connection of the machine control component.

After the machine control component has been set up and correctly allocated to the existing hardware elements, commands of the component can be inserted in a machine sequence (e.g. the production sequence). The user must activate this new machine configuration on the machine controller. During the activation of the new machine configuration, different tests and validations are performed, wherein the controller is configured so that the check and validation identifies, for example, an incomplete hardware association with the connection interfaces of the machine control components or multiple uses of hardware elements with several machine control components.

In particular when activating a new configuration of the machine controller, the difference between the new configuration and the actually stored machine configuration can be computed and only the difference from the previous production sequence can be stored on the machine controller.

The new components are now instantiated in the machine controller and the components no longer in use are deleted and altered components are adapted.

Using the same approach, existing machine control components can be altered, for example when a hydraulic ejector is to be replaced by an electric injector or when a machine control component is to be connected with other hardware inputs or outputs.

The present invention will now be described in particular with reference to the integration of auxiliary control components. These auxiliary control components are machine control components configured by the installer and are primarily used for controlling mold functions or peripheral devices. In addition to simple auxiliary control components, which may for example have only a single actuator (e.g. ejectors, core pullers, air valves), complex auxiliary control components with several actuators (e.g. telescopic ejector, rotary table, indexing plate, etc.) also exist. Auxiliary control components may also be preconfigured, wherein their data are then delivered with a data set that can be read into the machine controller.

When realizing the invention, care should be taken that the machine control components, in particular the auxiliary control components, can be configured so that they most accurately represents the real component.

A main focus of the present invention is that the equipment on the machine can be used flexibly and as needed, wherein the configuration and the operation of the injection molding machine, including the auxiliary control, should be simple and integrated. Overall, for example, auxiliary control components should be usable and parameterizable like normal machine control components. With respect to the employed terminology, a differentiation is made between:
Technology
Connection
Component type
Command
Appearance
Component category
Group.

The technology forms the basis of a machine control component. It includes the logic of the machine control component, determines the number and the type of the connections as well as the technology commands that can be used by the component type. For example, the following technologies are available for auxiliary control components:

| | Number | Connection | |
|---|---|---|---|
| Technology | connections | type | Use |
| Switching input | 1 | Switching input | Universal |
| Switching output | 1 | Switching output | Universal |
| Air valves | n | Pneumatic valve | Pneumatic valve |
| Pneumatic axis | 0-1 | Pneumatic valve | Valves direction |
| | | | A and B (at least |
| | | | one valve must |
| | | | be set) |
| | 0-1 | Pneumatic valve | |
| | 0-n | Position switch | End position A |
| | 0-n | Position switch | End position B |
| Hydraulic axis | 1 | Hydraulic valve | Proportional- or |
| | | | Servo valve |
| | 0-n | Position switch | End position A |
| | 0-n | Position switch | End position B |
| | 0-1 | Position switch | Switch position A |
| | 0-1 | Position switch | Switch position B |
| Hydraulic axis with | 1 | Hydraulic valve | Servo valve |
| distance | | | |
| measurement | | | |
| | 0-n | Position switch | End position A |
| | 0-n | Position switch | End position B |
| | 1 | Distance | Distance |
| | | measurement | measurement |
| | | system | system |
| Electric axis with | 1 | Electric motor | Motor, converter |
| distance | | | and resolver |
| measurement | | | |
| | 0-1 | Position switch | End position A |
| | 0-1 | Position switch | End position B |

In addition, for example the following connection types for the connection interfaces are available:

| Connection type | Remarks |
|---|---|
| Switching input | Floating relay input |
| Switching output | Floating contact output or semiconductor output |
| Position switch | Simple digital input |
| Pneumatic valve | Simple digital output |
| Hydraulic valve | Proportional- or Servo valve |
| Electric motor | Motor, converter and resolver |

A connection interface hereby represents the interface to an operating means (e.g. actuator or sensor).

A component type (e.g. standard ejector or telescopic ejector) is a concrete implementation of a machine control category or auxiliary control category. Among others, an appearance and a command are assigned to a component type. The appearances of all component types of a component category should hereby be identical.

The actions of a machine control component or of an auxiliary control component can be triggered with a command.

Exactly one appearance is associated with each component type.

All machine control types or auxiliary control types operating in a like manner are combined in one component category. For example, the standard ejector or the telescopic ejector is combined in the auxiliary control category “ejector.” For example, the following auxiliary control categories may be available for the auxiliary control components:
Switching input
Switching output
Blow molding control
Vacuum control
Mold air supply
Mold nozzle closure
Ejector
Core puller
Gate valve
Thread core
General linear axis
General rotary axis
Rotary table
Indexing plate.

The component types may be additionally grouped according to different criteria (e.g. mold group and peripheral group or standard components and custom a-specific components) if an increase in the number of component types is expected in the future.

Preferably, a hierarchical configuration is selected for the control software. This allocation corresponds substantially to the mirror image of the actual machine which is composed of individual components.

The use of technical components is specified in the uppermost logical layer of a software structure. A logical component representing a more extended component of the machine or the mold can be placed on top of one or several technical components. General linear axes, handling, boost ejector or rotary table are possible representatives of this layer. The logical component is responsible for the cooperation of the allocated technical components. The commands offered by the logical component can be used directly in the sequence editor.

The logical layer also defines the appearance of the component (e.g. the symbol and the designation of the component and of the command). The appearance (the symbol and in particular the designation of the components and commands) can be adapted by the machine operator.

Additional features of the invention are recited in the dependent claims.

The present invention will now be described in more detail with reference to an actual exemplary embodiment and with reference to the appended drawings. The drawings show in

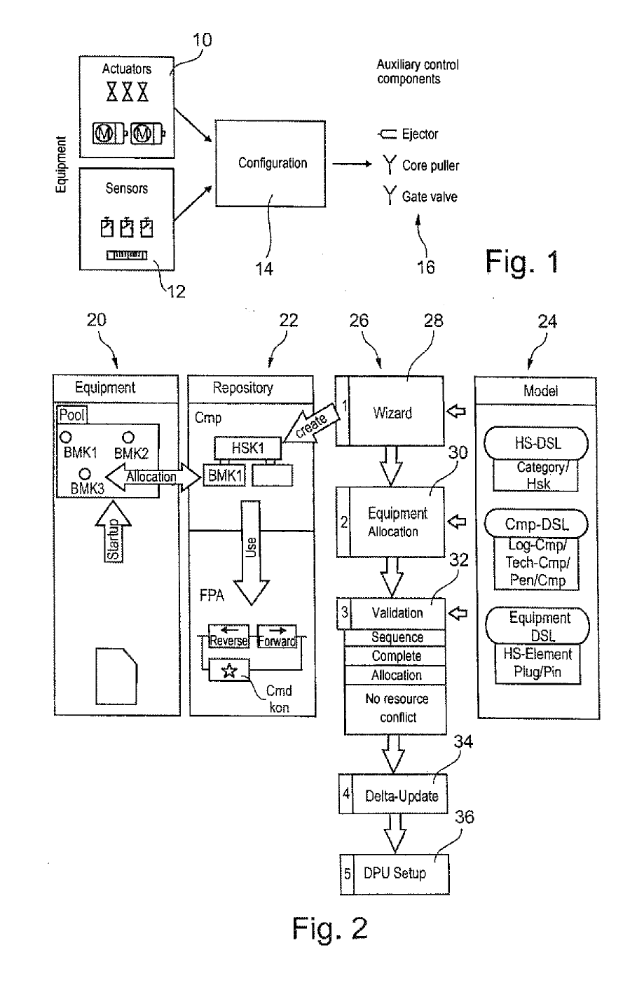

FIG. 1 a schematic diagram of the allocation of actually existing hardware connections of actuators and sensors to existing auxiliary control components,

FIG. 2 a schematic diagram of the steps for generating an auxiliary control component by resorting to stored information,

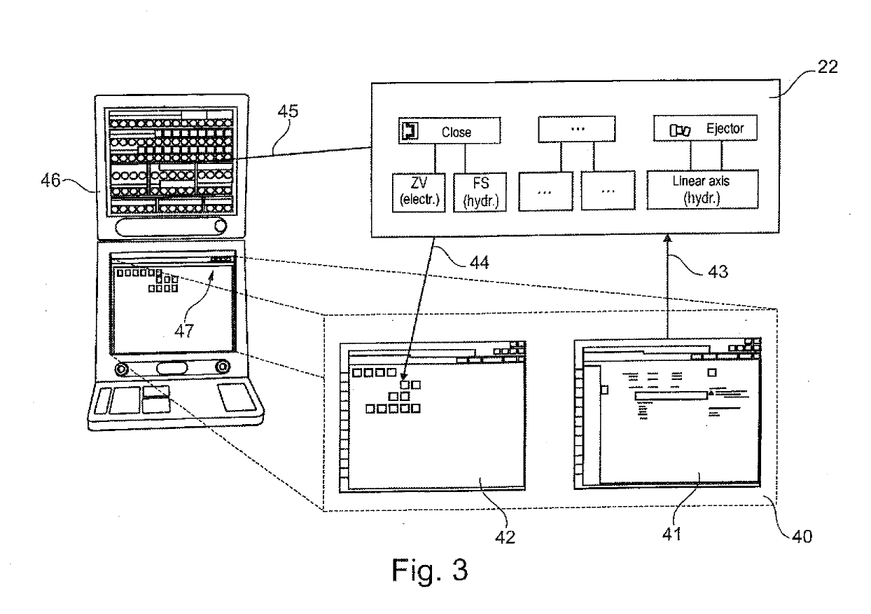

FIG. 3 a schematic diagram of the cooperation of sequence, configuration of the auxiliary control component and input device,

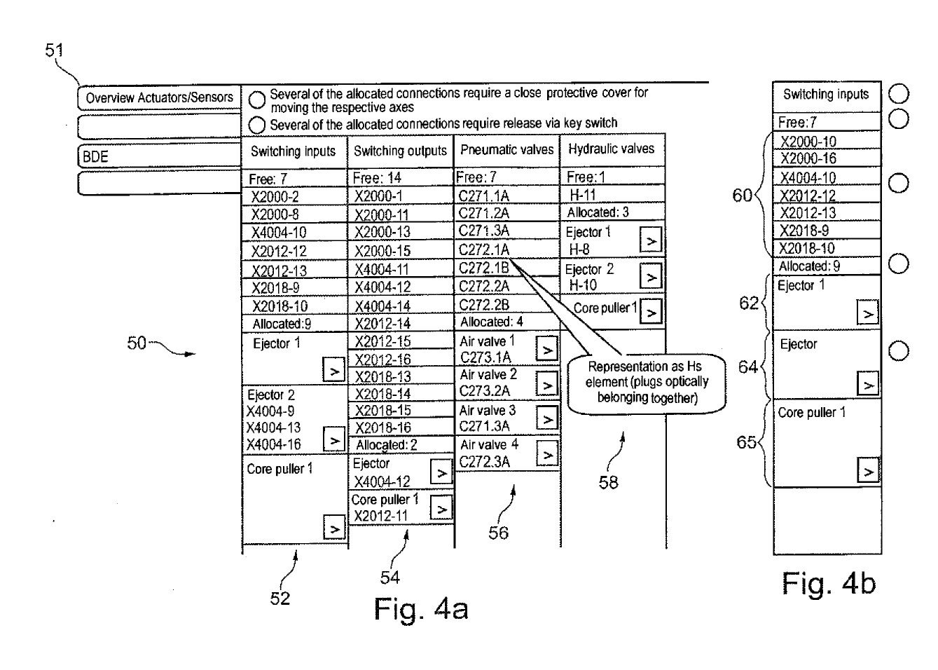

FIG. 4a a detail of a display screen with an overview over existing actual connections for actuators/sensors (hardware inputs and outputs),

FIG. 4b an explanation of the detail of the display screen of FIG. 4a based on the available connections for the switching inputs,

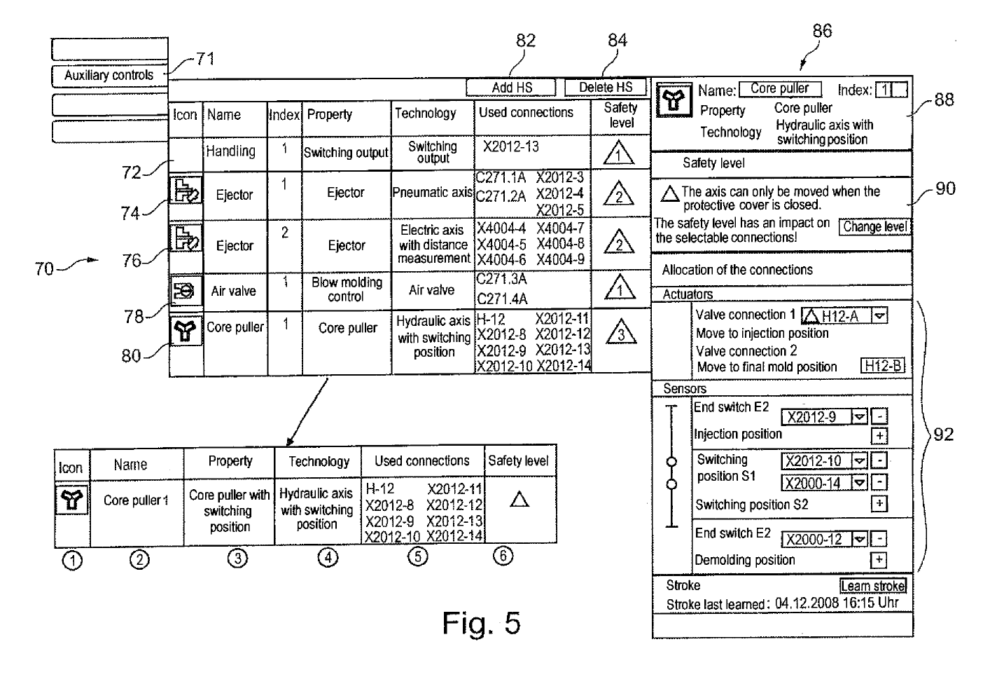

FIG. 5 a detail of a display screen with a display screen representation of existing or generated auxiliary control components,

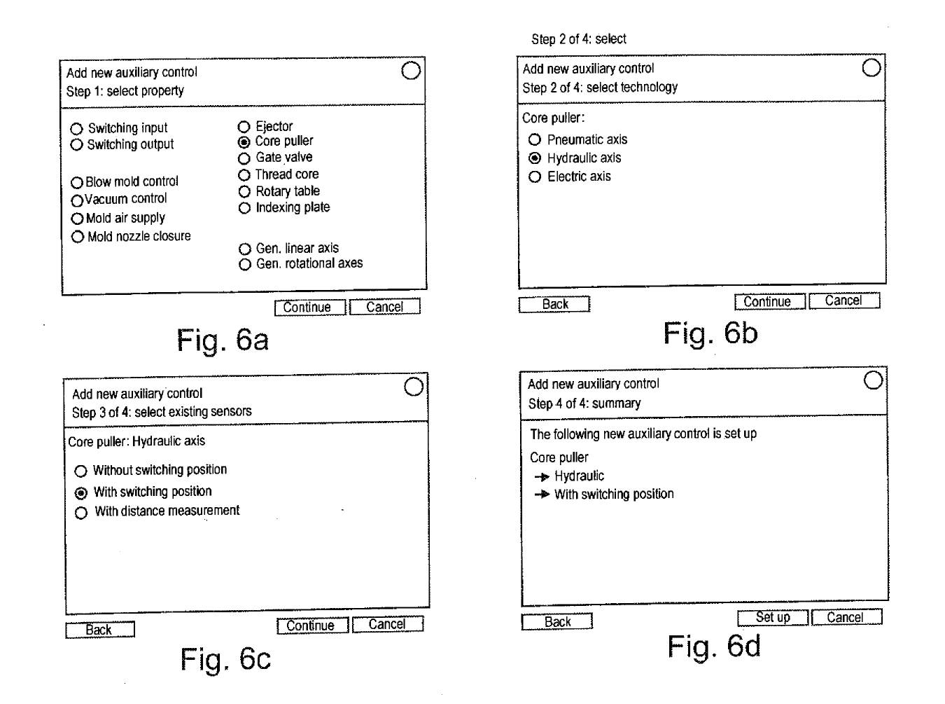

FIGS. 6a-6d different display screen windows for setting up a new auxiliary control component,

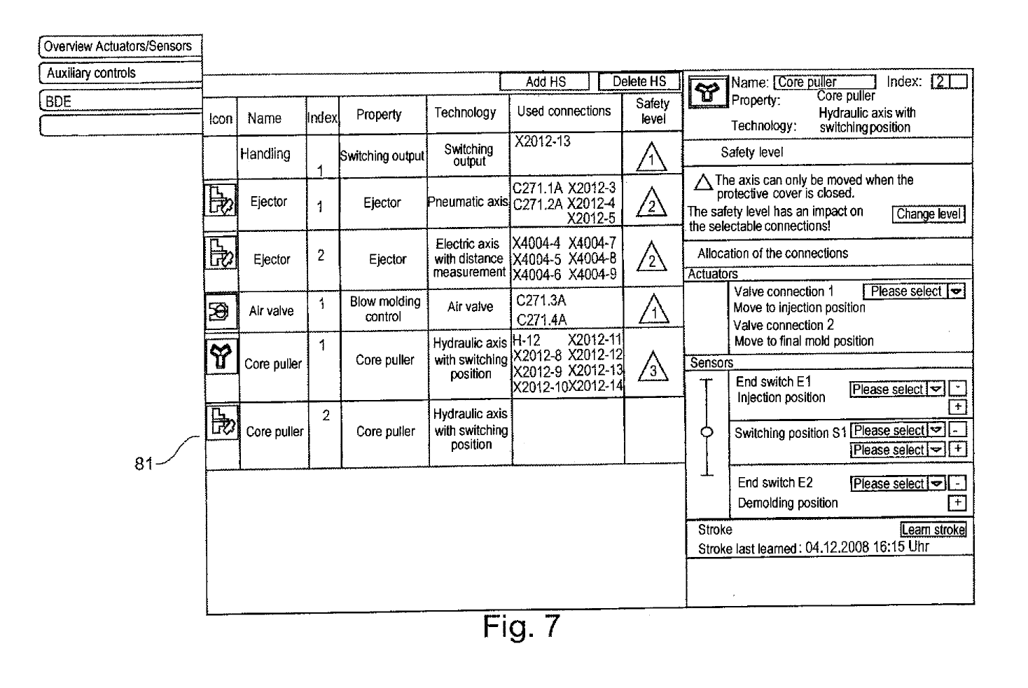

FIG. 7 a visualization of the newly set-up auxiliary control component (core puller) in a display screen representation,

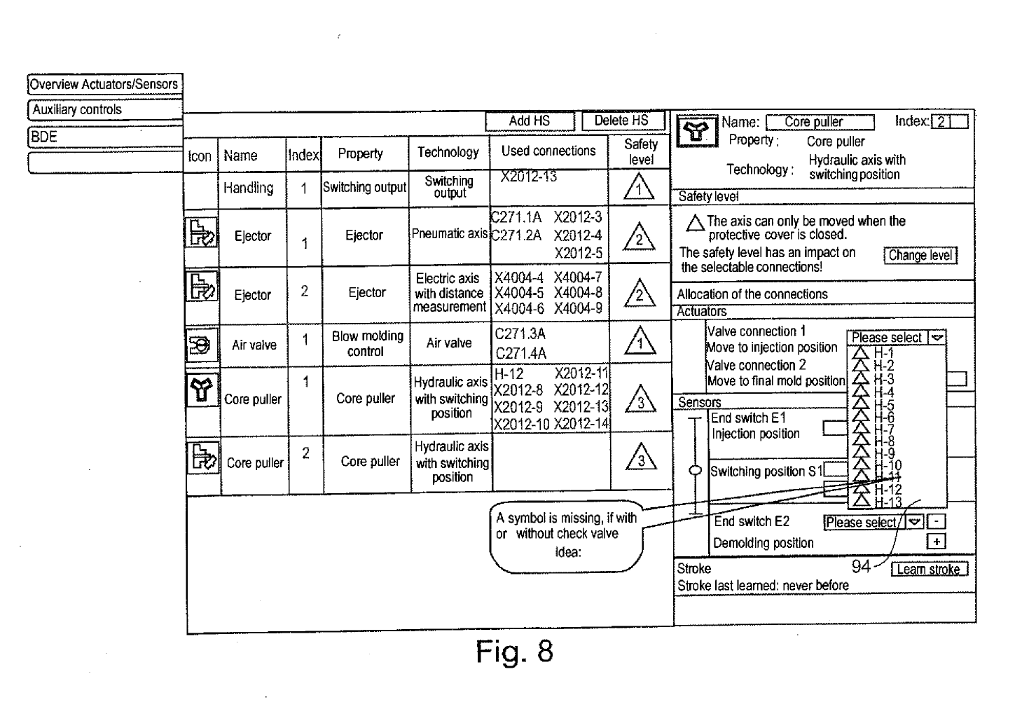

FIG. 8 a display screen visualization as in FIG. 7, showing the allocation of the connections to the hardware components,

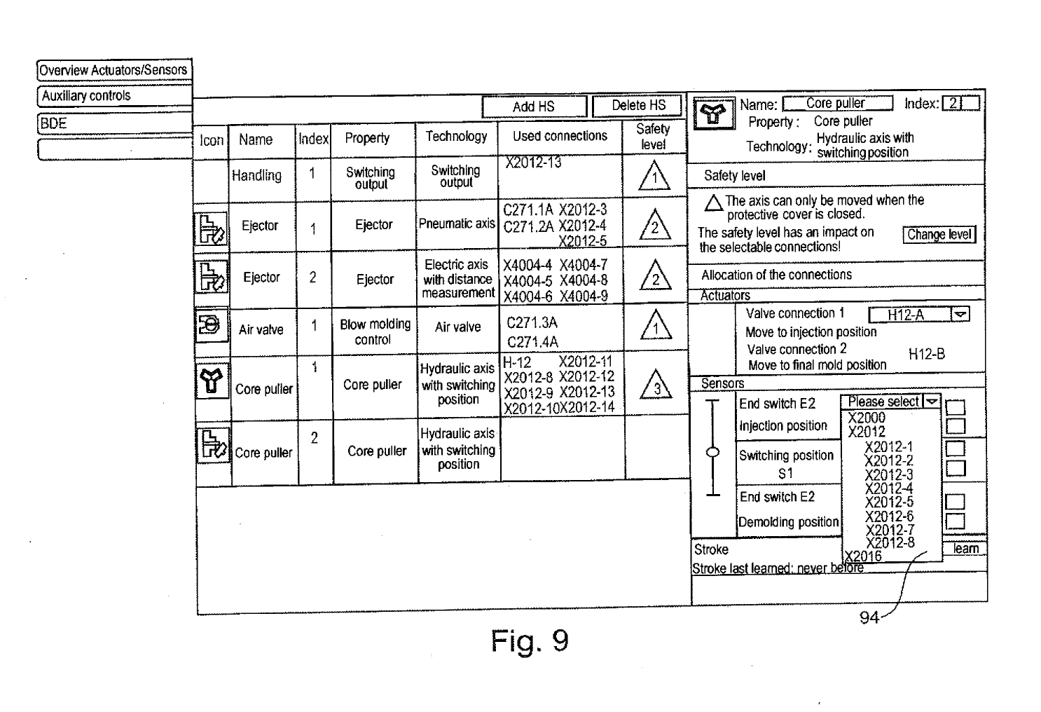

FIG. 9 a display screen representation as in FIG. 7, showing the allocation of the connection interfaces to the existing actual hardware components,

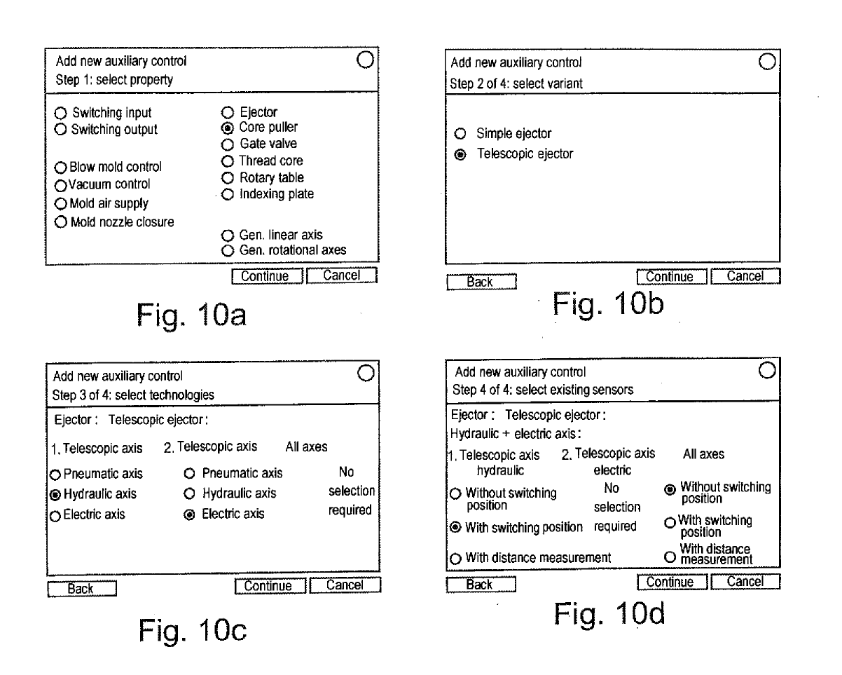

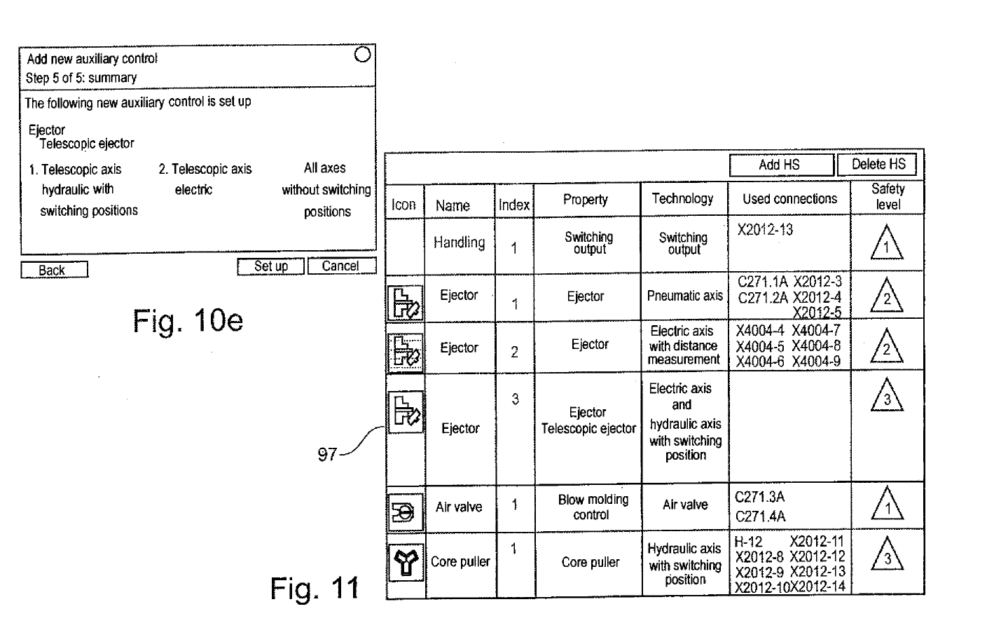

FIGS. 10a-e different display screen windows for setting up an additional new auxiliary control component, and

FIG. 11 an overview over existing or generated auxiliary control components.

According to the present invention, different connections for actuators and sensors with outputs and inputs (these can be analog or digital) are provided in an injection molding machine for a production cell. These existing hardware components (hardware elements with hardware inputs and outputs) are indicated in FIG. 1 by the reference symbols 10 (actuators) and 12 (sensors). On one hand, auxiliary control components, which can be generated according to the present invention and are indicated in FIG. 1 with the reference symbol 16, are required when using a specific mold. The present invention is directed to connect and correctly allocate the physically existing hardware elements, in particular the hardware inputs and outputs of the actuators and sensors, to the connection interfaces of the auxiliary control components.

The approach for generating a new auxiliary control component is illustrated in FIG. 2. The actually existing hardware components (connection possibilities) of a machine are stored in a storage area indicated as “equipment”. These actually existing hardware components (connection possibilities including their allocation) are read in during the startup of the machine, for example, from a file (for example an XML file or another file with structured content) and describe the equipment of the injection molding machine. The existing hardware inputs and outputs are stored in this storage area in a hardware pool. The use of the existing equipment is also administered in this area.

Only elements which are also physically implemented on the machine are located in the hardware pool, whereby the individual elements are identified by a device tag (BMK). The auxiliary control components generated by the operator are stored in the storage area referred to as “repository” (also referred to as machine control component pool) and subsequently become available to the sequence editor, which is indicated by the arrow “Use” in the area “FPA”.

When a new auxiliary control component is generated, the five steps indicated by the reference symbol 26 are executed in the present example. As indicated with the reference symbol 28, at a first step, an auxiliary control component is assembled with a software assistant (so-called Wizard), as desired.

For this purpose, a desired type is first selected from a set of predetermined auxiliary control types. Specific technologies are then available for each auxiliary control type. A technology is selected from this set of possible technologies for an auxiliary control type and added to the auxiliary control component. The technology indicates, for example, the manner in which the auxiliary control component is to be operated. The technology takes into account the auxiliary control axes, as will become clear below. Because the configuration of this auxiliary control is stored for each auxiliary control type, the controller is now aware of the allowed auxiliary control type for the selected auxiliary control component and the allowed technology.

Since the type and technology of the auxiliary control are now known, the software assistant can be closed, whereby the auxiliary control component is set up as software in the domain model and stored in the “repository” (machine control component pool). The auxiliary control component can now be used in the sequence editor. Because the auxiliary control component has not yet been assigned to the existing hardware elements, it cannot yet be activated for the machine control.

At the next step (reference symbol 30), the user connects the connection interfaces that were previously generated by the software assistant, i.e. inputs and outputs of the auxiliary control component, to the hardware elements actually present on the injection molding machine, which are stored in the hardware pool of the storage area (reference symbol 20). The controller hereby checks that only suitable hardware elements of a correct type are allocated.

At a next step (reference symbol 32), after the auxiliary control component are generated and the connections are allocated, the new configuration is activated on the machine control, with the machine control performing various validations and checks. The validations and checks identify incomplete hardware assignments of the auxiliary control component as well as multiple uses of hardware elements in several auxiliary control components.

After the check and validation, the actual configuration is loaded into the machine control, at step (reference symbol 34). For this purpose, for example, the difference between the new and the stored actual machine configuration is computed and only the difference is loaded into the machine control (delta-update).

At the next step (DPU setup, reference symbol 36), the new machine control components are added to the program code, the machine control components no longer in use are deleted and altered machine control components are adapted.

This concludes the setup of a new auxiliary control component. However, the auxiliary control component is not yet integrated in the production sequence or in another machine sequence. This will now be explained.

While FIG. 2 describes a rather abstract model for realizing the present invention, concrete exemplary embodiments will now be described.

FIG. 4a shows a visualization of the hardware connections available on a machine for actuators and sensors on a screen display. The tab 51 “overview actuators/sensors” is activated. This shows the actual hardware equipment represented in the storage area 20; this represents the hardware pool. In the present example, for example, all existing connections to the switching inputs, switching outputs, pneumatic valves and hydraulic valves are shown. The respective connections in FIG. 4a are sorted according to free connections and occupied connections. FIG. 4b shows as an excerpt column 52 with the “switching inputs”, indicating that the connections having the reference symbol 60 are available to the injection molding machine as free switching input connections. The connections arranged under the reference symbols 62, 64 and 65 for the switching inputs are assigned to the auxiliary control components “ejector 1”, “ejector 2” and “core puller”.

It is therefore clear to the operator from the diagram in FIG. 4a that seven free connections are still available for switching inputs, 14 free connections for switching outputs, seven free connections for pneumatic valves and one free connection for the hydraulic valves. These free connections can now be used for additional auxiliary control components.

In FIG. 5, which shows a screen visualization with an overview over the set-up auxiliary control components, the tab 71 “auxiliary controls” is activated via software. The auxiliary control components stored in the storage area 22 “repository” (machine control component pool) are thereby visualized. The rows labeled with the reference symbols 72, 74, 76, 78 and 80 illustrate the five auxiliary control components “handling”, “ejector 1”, “ejector 2”, “air valve” and “core puller” with their respective properties, the allocated technology, the used connections as well as the stored safety level.

In FIG. 5, the core puller shown in the last row with the reference symbol 80 is selected from the five auxiliary control components, causing the associated specification to be shown in the display screen section having the reference symbol 86. Specifically, the name, the property and the technology of the auxiliary control component are listed in the display screen section 88. In the present example, this is a core puller having allocated thereto the technology with a hydraulic axis and a switching position. Stage 3 is selected on the display screen section 90 as the safety level, whereby the axis can only be moved when the protective cover is closed. In the display screen section 92, the connection interfaces of the technology “hydraulic axis with switching positions” are connected with the hardware inputs and outputs referenced in the fields for the valve connection, the end switch and the position switch for the switching position. The allocated hardware inputs and outputs can also be changed in the fields by a different allocation.

As a result, an overview of the already existing auxiliary control components and their configuration is obtained with the display screen section illustrated in FIG. 5.

If a new auxiliary control component is to be added to the existing auxiliary control components, then the control knob 82 “Add HS” is operated. A window with a software assistant (also referred to as Wizard) is then opened, in which a predetermined number of auxiliary control types is listed (see FIG. 6a). After a core puller was selected in FIG. 6a as an auxiliary control type, the technology can be selected by operating the control knob “continue”, at step 2. Three technologies are offered for the auxiliary control type “core puller”: namely pneumatic (“pneumatic axis”), hydraulic (“hydraulic axis”) and electrically operated axis (“electrical axis”). One technology can now be selected from the offered technologies. If a different auxiliary control type is to be selected at step 1, then it will be understood that other technologies would be offered. When the control knob “continue” is operated in FIG. 6b, then the process goes to step 3 where the presence of a switching position (sensor) can be indicated for a core puller with hydraulic axis. When this switching position is selected according to the situation and when the control knob “continue” in FIG. 6c is operated, then the software assistant is closed and the auxiliary control component core puller with the specification hydraulic and the corresponding configuration for the switching position is generated. This auxiliary control component is from this time on also listed in the control area 22 under “repository” as a new auxiliary control component (reference symbol 81) and can now also be used in the sequence editor.

Based on the selection of the auxiliary control types and the technology, it is clear from the logic stored in the storage area 24 “model” which terminals must be allocated to the auxiliary control component. In the present example, these are for the auxiliary control component “core puller 2” the connections “valve connection 1—go to injection position”, “end switch E1—injection position”, “switching position S1” and “end switch E2—in demolding position”. The connection interfaces for the actuators and/or sensors must now be connected with the actual hardware elements on the injection molding machine. For this purpose, as illustrated in FIG. 8, the available valve connections are listed by opening the pull-down menu of the available valve connections when allocating a hardware element to the valve connection 1, for which now a suitable connection can be selected. In the present example, this is the connection H12-A. The valve connection 2 is automatically allocated to the second connection H12-B of the selected valve. Furthermore, a movement direction is allocated to each valve connection. In the present example, this is “go to injection position” for valve connection 1 and “go to demolding position” for the valve connection 2. In addition, the corresponding hardware elements can also be allocated to the sensors by way of the pull-down menus. This is illustrated in FIG. 9 by the pull-down menu 96, for example for the end switch E1. In this way, the available hardware elements can be allocated to the connections for the newly generated auxiliary control components. Thereafter, the allocated connections are also shown in the display screen visualization.

FIGS. 10a-10e illustrate the setup of an additional auxiliary control component. When the control knob 82 “add HS” is operated, the software assistant once more opens, which is used to select an “ejector” at step 1 (see FIG. 10a), whereby either a “simple ejector” or a “telescopic ejector” can be selected as variants by operating the control knob “continue” (see FIG. 10b). When the variant “telescopic ejector” is selected, different technologies are offered, namely the type of the axes for the first and the second telescope axis (see FIG. 10c). After the technology has been selected, the existing sensors on the telescope ejector can be selected in FIG. 10d and the corresponding auxiliary control component is added according to FIG. 10a after termination of this step. When the corresponding connections are subsequently allocated, the newly generated auxiliary control component is visualized in FIG. 11 with the reference symbol 97. After the auxiliary control components have been generated and allocated to the hardware inputs and outputs and are activated, they can be used in a conventional manner in a domain model, as described in WO 2006/089451, wherein the operator can use the auxiliary control component when modeling the production sequence. If the operator performs such modeling and hence adapts the production sequence, then the new configuration must be transferred to the machine controller. In other words, the new configuration must be activated on the machine controller. It is hereby checked if the allocation of the hardware elements to the auxiliary control components is complete or incomplete or if hardware elements have been assigned multiple times (validation). According to a preferred embodiment, the difference between the new configuration and the actually loaded configuration is computed and loaded into the machine controller.

The aforedescribed sequence is illustrated in a different diagram in FIG. 3. FIG. 3 indicates a control terminal with a lower display screen, on which in the present example a machine sequence is visualized in the domain language. In the display screen arranged above, an onscreen keyboard is shown with which haptic control keys can be dynamically assigned, labeled and provided with a symbol (see also EP 2 100 197 A1).

First, the component configurator 41 is called on the lower display screen—as shown on the right-hand side of the screen page 40. For example, the operator can generate with the component configurator 41 machine-specific components (e.g. auxiliary control components) by using the software assistant. When the component type and the technology—as previously described—are determined, the component may be placed in the component repository 22 (step 43—“generating and storing the new auxiliary control component”). The auxiliary control component is now available to the sequence editor. Before the new auxiliary control component can be activated, the connections of the corresponding component must be allocated. At the next step (step 44—“inserting the command in the sequence”), the commands of the auxiliary control component from the repository 22 are transmitted to the sequence editor and can now be inserted by the operator into the production sequence at a suitable position.

In the activation, all changes (for example new auxiliary control component, adapted sequence, altered parameterization, etc.—reference symbol 47—step: “activate change”) are loaded into the machine control. Preferably, changes can only be activated when all the information is correct and complete (validation). When a new auxiliary control component has been successfully activated, this is indicated on the control keys by the corresponding allocation (reference symbol 45—display on the control keys).

In the same manner, auxiliary control components that are no longer needed can be selected first and then deleted with the control knob 84 “delete HS”. In this way, for example certain hardware elements required for other auxiliary control components can be released again.

Moreover, a configuration for an auxiliary control component can be altered in the manner described above by, for example, selecting a different technology, a different safety level or another allocation of the connections.

In summary, the present invention provides a flexible use of injection molding machines in production cells. Hardware elements provided on a machine, such as connections for actuators and sensors, can be configured for universal use. Based on these universally usable connections for actuators and sensors, auxiliary control components can be generated and configured, like those provided in new mold tools or peripheral devices. Injection molding machines equipped with hardware elements in a specific manner can then be used for a variety of applications.

List of references symbols
10 Totality of available actuators with connections (inputs and outputs)
12 Totality of available sensors with connections (inputs and outputs)
14 Configuration
16 Set up machine control components, here auxiliary control components
20 Storage area for existing hardware connections on the injection molding machine or the production cell
22 Storage area for set-up machine control components
24 Storage area for models of the machine control components
26 Five steps for setting up an auxiliary control component for the machine sequence
28 Step “setting up a control component with Wizard”
30 Step “allocation of the hardware connections (equipment allocation)”
32 Step “checking and validating the control component and allocation to the control component”
34 Step “determining the differences in existing and new machine configuration”
36 Step “adaptation of the sequence program to the new machine configuration”
40 Screen page
41 Component configurator
42 Sequence editor
43 Step: generating the new auxiliary control component
44 Step: inserting the command into the sequence
45 Displaying the control keys
46 Control terminal
47 Step: activating the change
50 Display screen detail with overview over hardware inputs and outputs of the existing actuators and sensors
51 Tab “overview actuators/sensors”
52 Overview over free and allocated connections for switching inputs
54 Overview over free and allocated connections for switching outputs
56 Overview over free and allocated connections for pneumatic valves
58 Overview over free and allocated connections for hydraulic valves
60 Overview over free connections for switching inputs
62 Overview over switching inputs allocated to the machine control component “ejector 1”
64 Overview over switching inputs allocated to the machine control component “ejector 2”
66 Overview over switching inputs allocated to the machine control component “core puller 1”
70 Display screen detail with overview over set-up machine control components
71 Tap “auxiliary controls”
72 Representation for the auxiliary control component “handling”
74 Representation for the auxiliary control component “ejector 1”
76 Representation for the auxiliary control component “ejector 2”
78 Representation for the auxiliary control component “air valve”
80 Representation for the auxiliary control component “core puller”
81 Representation for the newly added auxiliary control component “core puller”
82 Control knob for adding an auxiliary control component
84 Control knob for deleting an auxiliary control component
86 Specifying a selected auxiliary control component
88 Visualization of the component type and the technology
90 Visualization of the safety level
92 Visualization of the connection allocation
94 Selection menu (pull-down menu) for selecting the valve connection
96 Selection menu (pull-down menu) for selecting the end switch E1
97 Representation for the newly added auxiliary control component “ejector 3”

1. -17. (canceled)

18. A method for controlling and operating a production cell which includes at least a portion of peripheral devices associated with the production cell, comprising the steps of:
generating, administering and executing, with a domain language, machine sequences based on machine control components, which are part of a domain model, and
generating or altering a machine control component that is part of the domain model by
selecting a machine control component from a set of predetermined component types,
allocating a permissible technology from a set of technologies for the respective component type,
storing for each technology of a component type a logic which includes connection interfaces required for the respective technology and defines the connection interfaces for the machine control component, and
allocating the connection interfaces of the generated machine control component to suitable hardware inputs and outputs of existing connections of an injection molding machine or the production cell.

19. The method of claim 18, and further checking if allocating a technology to the machine control component is permissible.

20. The method of claim 18, and further storing all existing or generated machine control components in a component pool.

21. The method of claim 20, and further using the generated machine control component, after the generated machine control component is stored in the component pool, in a configuration of a machine sequence for describing the machine sequence by using the domain language.

22. The method of claim 18, and further administering all hardware inputs and outputs of existing connections of the production cell in a hardware pool.

23. The method of claim 18, and further checking correctness of an allocation, when allocating the connection interfaces of a machine control component to a hardware input or output.

24. The method of claim 18, and further checking completeness or permissibility of allocations after adjusting or changing a machine control component when transferring the allocations to a machine controller.

25. The method of claim 18, and further exporting and importing a machine configuration.

26. The method of claim 18, wherein the hardware inputs and outputs are selected from existing connections of the production cell when the hardware inputs and outputs are allocated to connection interfaces of a machine control component from a connection pool of free connections.

27. A device for controlling and operating a production cell, comprising:
an operating device allowing an operator to define and parameterize a production sequence,
a storage device, and
a computer configured to
receive a knowledge base and to generate on the operating device an image of at least a portion of devices existing on or being allocated to the production cell in a domain model in form of machine control components,
generate, administer and execute machine sequences using a domain language, wherein a machine control component is newly generated or altered as part of the domain model,
store in the storage device a set of predefined component types for selection of a new machine control component,
store in the storage device for each component type a set of technologies adapted to be allocated to a machine control component of a component type,
allocate a logic and interfaces required for each technology of a component type, and
allocate hardware inputs and outputs of existing connections of the production cell to connection interfaces of generated machine control components.

28. The device of claim 27, wherein the computer is configured to test permissibility of allocation of a technology to a machine control component.

29. The device of claim 27, further comprising a memory device for storing existing or generated machine control components in form of a component pool.

30. The device of claim 29, wherein the computer is configured to integrate generated machine control components in a machine controller after the machine control components are stored in the component pool.

31. The device of claim 27, wherein the computer is configured to check correctness of the allocation of a connection interface of the machine control component to the hardware input or output of existing connections.

32. The device of claim 27, wherein the computer is configured to determine, after adjustment or change of a machine control component and its use in the domain model, a deviation from an existing production sequence and to change the machine controller for implementing the changes in the production sequence.

33. The device of claim 27, wherein the computer is configured to import or export, or both, the machine configuration.

34. The device of claim 27, wherein the computer is configured to check proper connection of the connection interfaces of a machine control component with hardware inputs and outputs of existing connections of the production cell.
